(19) United States
(12) Patent Application Publication
(10) Pub. No.: US 2023/0235588 A1
(43) Pub. Date: Jul. 27, 2023

(54) BEACH UMBRELLA WITH MOTORIZED IMPLANTING BASE

(71) Applicants: Joseph Hauter, Coral Springs, FL (US); Ellen Cohen, Coral Springs, FL (US)

(72) Inventors: Joseph Hauter, Coral Springs, FL (US); Ellen Cohen, Coral Springs, FL (US)

(21) Appl. No.: 18/098,488

(22) Filed: Jan. 18, 2023

Related U.S. Application Data
(60) Provisional application No. 63/302,201, filed on Jan. 24, 2022.

(51) Int. Cl. E04H 12/22; A45B 23/00

(52) U.S. Cl. CPC E04H 12/2223; A45B 23/00; A45B 2023/0012; A45B 2200/1009; H02J 7/0042

(57) ABSTRACT

A beach umbrella with motorized implanting base that includes an elongated pole member having a motor coupled thereto and electrically coupled to a battery coupled to the elongated pole member, and having an anchor member with a threaded configuration, forming a terminal end of the elongated pole member, and rotatably coupled to the elongated pole member, wherein the motor is operably configured to selectively rotate the anchor member 360° clockwise and counterclockwise independent of a portion of the elongated pole member. The umbrella also includes a canopy covering coupled to the elongated pole member, of a flexible material, and operably configured to have a retracted position with the canopy covering disposed in a longitudinal orientation and an open position with the canopy covering disposed in a horizontal orientation relative to the elongated pole member.

### FIELD OF THE INVENTION

The present invention relates generally to umbrellas for use at the beach and, more particularly, relates to beach umbrellas with poles operably configured to be inserted into the beach sand.

### BACKGROUND OF THE INVENTION

Many people utilize umbrellas to shelter themselves from the elements, i.e., snow, rain, and sun. Utilizing an umbrella at the beach is especially problematic due to wind typically generated by the ocean. Said another way, most beach umbrellas have a larger covering or canopy than most conventional umbrellas, leaving them more conducive to experiencing larger uplift forces that inadvertently remove the umbrella from the beach sand.

Most known beach umbrellas utilize a two-part system including a base assembly with spiked or tapered end and a spiral flange or screw configuration configured to be inserted into a ground surface. The base includes an upper opening for a pole of the umbrella to be inserted, wherein the pole of the umbrella is then secured to the base using, for example, one or more fastener(s). Some known base assemblies utilize handles to facilitate in generating sufficient torque to enable the base assembly to be inserted into the ground surface at a sufficient depth that prevents the umbrella from being inadvertently removed. For many users, particularly the elderly and those with physical disabilities, generating sufficient torque for the base assembly can be problematic due to physical capabilities of the user and/or the density of the ground surface (particularly at depths greater than 15-30 cm).

Many known umbrella systems enabling a user to thread or insert a base assembly into a ground surface require the base assembly to be independent of the umbrella pole. This configuration also often prevents the user from obtaining the correct position of the umbrella until the user first installs the base assembly. If positioned incorrectly, the user must remove the base assembly and restart the process, which is time-intensive and sometimes physically exhausting. Those known umbrella systems also lack versatility and functionality that many users desire.

Therefore, a need exists to overcome the problems with the prior art as discussed above.

### SUMMARY OF THE INVENTION

The invention provides a beach umbrella with motorized implanting base that overcomes the hereinafore-mentioned disadvantages of the heretofore-known devices and methods of this general type and that effectively and efficiently enables users to insert and remove an umbrella from a ground surface, notwithstanding the user's age or physical abilities.

With the foregoing and other objects in view, there is provided, in accordance with the invention, a beach umbrella with motorized implanting base having an elongated pole member having a motor coupled thereto and electrically coupled to a battery coupled to the elongated pole member, and having an anchor member with a threaded configuration, forming a terminal end of the elongated pole member, and rotatably coupled to the elongated pole member, wherein the motor is operably configured to selectively rotate the anchor member 360° clockwise and 360° counterclockwise independent of a portion of the elongated pole member. The beach umbrella also includes a canopy covering coupled to the elongated pole member, of a flexible material, and operably configured to have a retracted position with the canopy covering disposed in a longitudinal orientation and an open position with the canopy covering disposed in a horizontal orientation relative to the elongated pole member.

In accordance with another feature, an embodiment of the present invention includes a button disposed on the elongated pole member at least 15% a pole member length above the terminal end of the elongated pole member and configured to selectively activate the motor and rotate the anchor member, the pole member length defined by two opposing ends of the elongated pole member.

In accordance with yet another feature, an embodiment of the present invention also includes a USB charging port electrically coupled to the battery and disposed on the elongated pole member at least 15% the pole member length above the terminal end of the elongated pole member.

In accordance with a further feature of the present invention, the elongated pole member and the anchor member are of a unitary structure.

In accordance with an additional feature of the present invention, the elongated pole member tapers in thickness toward the terminal end to form a point.

In accordance with a further feature of the present invention, the elongated pole member encapsulates the motor, the motor comprising an axle disposed in a longitudinal orientation and shaped and sized to mate with a proximal end of the anchor member.

In accordance with an exemplary feature of the present invention, the motor operates on 18 VDC, has a power output of approximately 250 W, and is operably configured to rotate approximately 300 RPM.

Also in accordance with the present invention, a beach umbrella with motorized implanting base is disclosed that includes a pole member with a first end, a second end opposing the first end of the pole member, a pole member length separating the first and second ends of the pole member, having a motor coupled thereto, disposed proximal to the second end, and electrically coupled to a battery coupled to the pole member, and having an anchor member coupled to the second end of the pole member, with a threaded configuration, having a terminal end, a proximal end opposing the terminal end and operably coupled to the motor, and rotatably coupled to the pole member, wherein the motor operably is configured to selectively rotate the anchor member 360° clockwise and 360° counterclockwise independent of the pole member. Further, the beach umbrella includes a canopy covering coupled to the pole member, of a flexible material, and operably configured to have a retracted position with the canopy covering disposed in a longitudinal orientation and an open position with the canopy covering disposed in a horizontal orientation relative to the pole member.

In accordance with another feature, an embodiment of the present invention includes a button disposed on the pole member at least 15% the pole member length above the second end of the pole member and configured to selectively activate the motor and rotate the anchor member.

In accordance with another feature, an embodiment of the present invention includes a USB charging port electrically coupled to the battery and disposed on the pole member at least 15% the pole member length above the second end of the pole member.

Although the invention is illustrated and described herein as embodied in a beach umbrella with motorized implanting base, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the pole of the umbrella.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective overhead view of a beach umbrella with motorized implanting base in accordance with one embodiment of the present invention;

FIG. 2 is a fragmentary perspective underneath view of the beach umbrella depicted in FIG. 1;

FIG. 3 is a bottom plan view of the beach umbrella depicted in FIG. 1;

FIG. 4 is an exploded view of a pole member 102 and anchor member 106 utilized with the beach umbrella depicted in FIG. 1;

FIGS. 5-6 are fragmentary front and rear views, respectively, of the beach umbrella depicted in FIG. 1; and

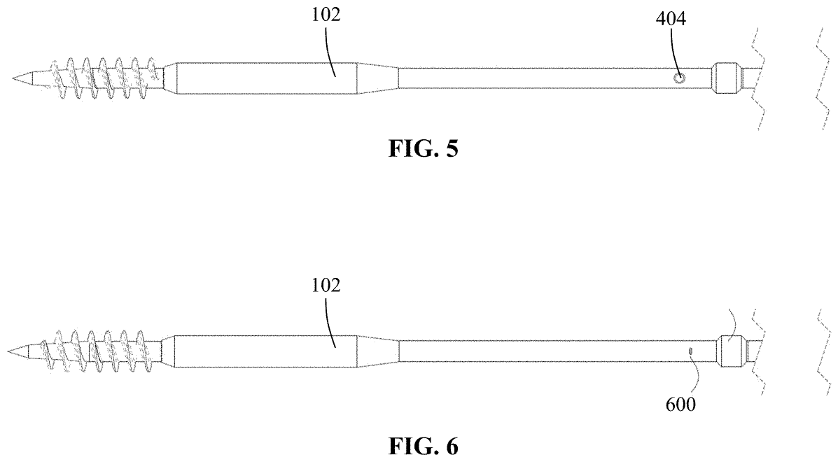

FIGS. 7-8 are fragmentary left-side and right-side views, respectively, of the beach umbrella depicted in FIG. 1.

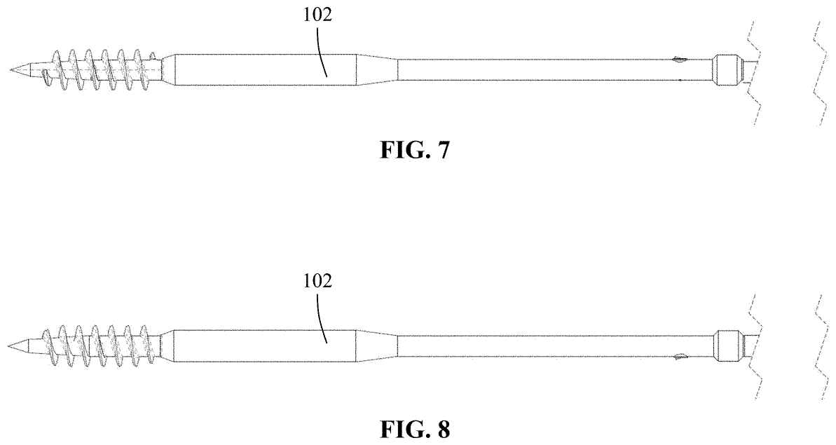

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient beach umbrella with motorized implanting base. Although the present invention has been designed to be particularly advantageous to beach environments with sand, it may be applicable to other ground surfaces unless specifically stated otherwise.

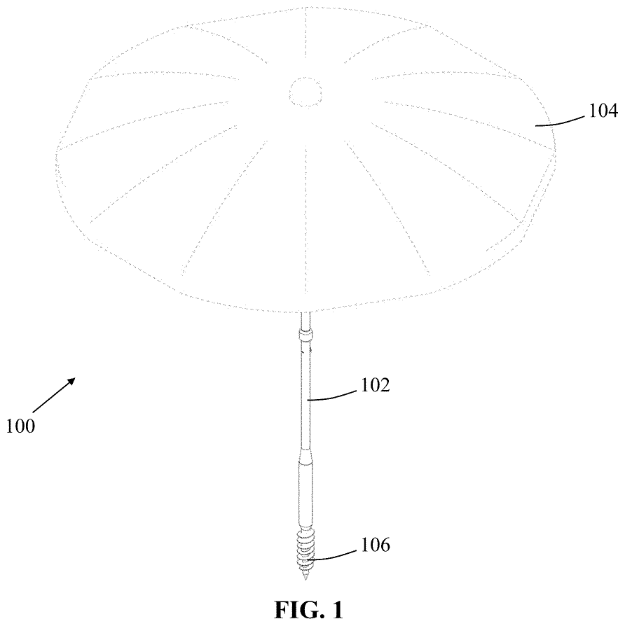

Referring now to FIG. 1, one embodiment of the present invention is shown in a perspective overhead view. FIG. 1 shows several advantageous features of the present invention, but, as will be described below, the invention can be provided in several shapes, sizes, combinations of features and components, and varying numbers and functions of the components. The first example of a beach umbrella with motorized implanting base, as shown in FIG. 1, includes a pole member 102 and a canopy covering 104, wherein the pole member 102 can be seen having an anchor member 106 that is configured to be selectively rotated by the user to facilitate in implanting and removing the umbrella from the ground surface. In preferred embodiments, the pole member 102 is elongated, in that its overall length is greater than its average diameter or width.

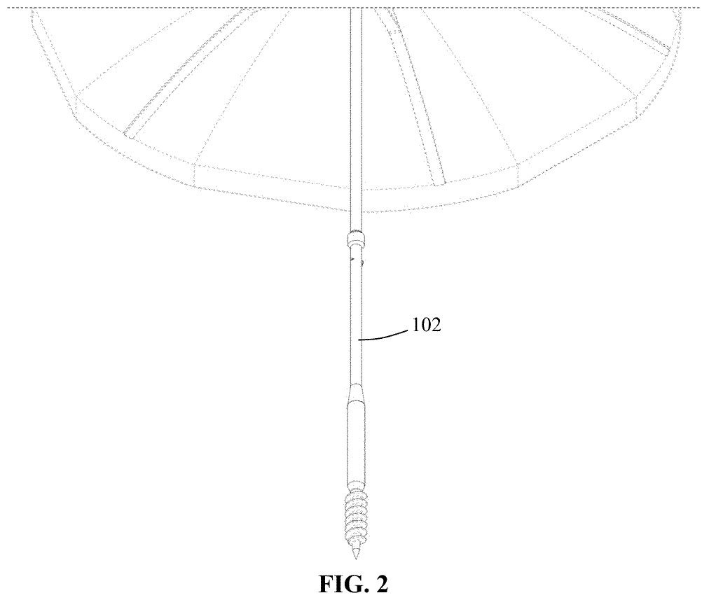

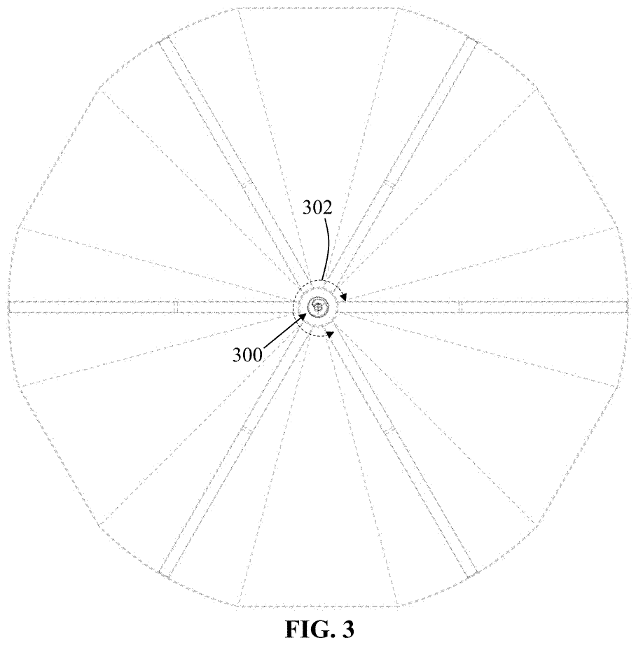

In one embodiment, the elongated pole member 102 is of a substantially rigid yet lightweight material, such as polypropylene, PVC, thin gauged stainless steel, or aluminum. The elongated pole member 102 may be of a tubular structure having an overall diameter or width of approximately 25-50 mm. The canopy covering 104 can be seen best in FIGS. 2-3 coupled to the elongated pole member 102 and being of a flexible material, such as polyester canvas. The canopy covering 104 may include a framing assembly of a substantially rigid material that enables the canopy covering to be operably configured to have a retracted position with the canopy covering 104 disposed in a longitudinal orientation and an open position with the canopy covering 104 disposed in a horizontal orientation relative to the elongated pole member 102 (exemplified in FIG. 1 and FIG. 3). Said another way, the canopy covering 104 may be manipulated by the user, e.g., using a button, to be placed in the open position with a diameter of approximately 200-250 cm, wherein the canopy covering 104 is substantially enclosed to prevent radiated sunlight from passing therethrough. In some embodiments, the canopy covering 104 may include an air entrance at the top to permit the flow of air therethrough and minimize the uplift forces generated or near the beach. The pole member 102 may also include an angle pin to permit rotation, pivoting, and/or locking of the canopy covering 104 in various positions. It should be understood that terms such as, “front,” “rear,” “side,” top,” “bottom,” and the like are indicated from the reference point of a viewer viewing the umbrella as shown in the figures.

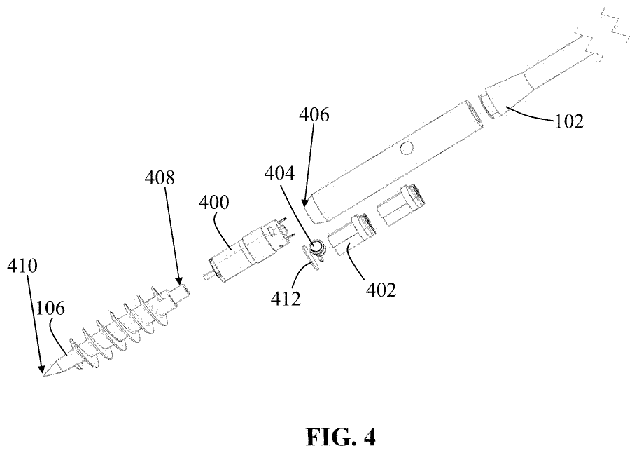

The elongated pole member 102 may be formed with multiple sections joined together using fasteners, adhesive, etc., or may be of a monolithic structure. Regardless, the elongated pole member 102 and the anchor member 106 are preferably of a unitary structure, i.e., connected together to be utilized as one piece and not formed in two pieces like the prior art. Exemplary sections can be seen depicted in the exploded view of the umbrella 100 in FIG. 4. In one embodiment, the pole member 102 may be described as having a first end 300 (best seen depicted in FIG. 3), a second end 406 (best seen depicted in FIG. 3) opposing the first end 300 of the pole member 102 and a pole member length separating the first and second ends 300, 406 of the pole member 102. The pole member length may be approximately 140-180 cm and is generally a height that enables the canopy covering 104 to be approximately 5-6 feet above the ground surface when the anchor member 106 is implanted into the ground surface.

As seen best in FIG. 1 and FIG. 4, the motor 400 may be coupled to the pole member 102 and electrically coupled to one or more batteries 402 using for example, wiring or electrical contacts. To generate sufficient power to the motor 400, the battery may be a lithium-ion 3 Ah and 18 VDC battery coupled to the elongated pole member 102. The motor 400 also preferably operates on 18 VDC, has a power output of approximately 250 W (i.e., +/−25 W), and is operably configured to rotate approximately 300 RPM (i.e., +/−100 RPM).

The anchor member 106 of the umbrella 100 also includes a threaded configuration (i.e., shaped as a screw or having spiral radial flanges as depicted in the figures), wherein, in one embodiment, can be described as forming a terminal end of the elongated pole member 102. The anchor member 106 may have a proximal end 408, a terminal end 410 opposing the proximal end 408, and an anchor length separating the proximal and terminal ends 408, 410. The anchor length may be approximately 20-25 cm and each of the spiral flanges may be equally spaced from one another.

The anchor member 106 may also be of a substantially rigid material and is rotatably coupled to the elongated pole member 102, wherein the motor 400 is operably configured to selectively rotate the anchor member 106 360° clockwise and 360° counterclockwise independent of a portion of the elongated pole member 102. Said another way, depending on the screw configuration, the motor 400 is configured to continually rotate the anchor member 106 clockwise to implant the anchor member 106 in the ground surface and continually rotate the anchor member 106 counterclockwise to remove the anchor member 106 from the ground surface. Exemplary directions of rotation can be seen depicted in FIG. 3 with arrow 302.

In one embodiment, a PCB board 412 is utilized with the motor 400 and includes a programed time in which the motor 400 rotates the anchor member 106 to sufficiently implant the anchor member 106 into the ground surface. In other embodiments, a button 404 is utilized and configured to selectively activate the motor 400 and rotate the anchor member 106, i.e., the depression or modulation of the button 404 connects a circuit that provides power to the motor 400 and permits the user to rotate the anchor member 106 as much as needed. The assembly or button 404 may also include the ability for the user to select the desired direction of rotation, i.e., clockwise or counterclockwise, through use of another switch.

In one embodiment, the button 404 is disposed on the elongated pole member 102 at least 15% the pole member length above the terminal end of the elongated pole member 102, wherein the pole member length is defined by the two opposing ends 300, 410 of the elongated pole member 102. In preferred embodiments, the button 404 is located approximately 48-58 cm above the terminal end 410 of the anchor member 106, thereby providing users quick access to the button 404. In one embodiment, the umbrella 100 also includes a USB charging port 600 (e.g., USB-C) electrically coupled to the battery 402 and disposed on the elongated pole member 102 also at least 15% the pole member length above the terminal end of the elongated pole member 102. The USB charging port 600 may also be physically coupled to the button assembly and is also beneficially located for quick access and charging of a user's phone.

The motor 400 may also be coupled to the pole member 102 such that it is disposed proximal to the second end 406, i.e., at or near (within 15 cm). The anchor member 106 is then coupled to the second end 406 of the pole member 106, and includes a terminal end 410 and a proximal end 408 opposing the terminal end 410 and operably coupled to the motor 400. Said another way, the motor 400 includes an axle disposed in a longitudinal orientation and shaped and sized to mate with a proximal end 408 of the anchor member 106, e.g., using a female/male coupling configuration. In one embodiment, the shape of the axle comports with the shape of the end 408 of the anchor member 106 and may be locked into place with, for example, friction and/or one or more fastener(s).

As best seen in FIG. 4, the elongated pole member 102 beneficially encapsulates the motor 400 and other electrical components to shield them from the environment. Additionally, the elongated pole member 102, specifically the terminal end 410 of the anchor member 106, can be seen tapering in thickness toward the terminal end 410 to form a point, thereby enabling the anchor member 106 to more easily access the ground surface.

Although a specific order of executing the implantation and removal process has been described and depicted, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A beach umbrella with motorized implanting base comprising:
an elongated pole member having a motor coupled thereto and electrically coupled to a battery coupled to the elongated pole member, and having an anchor member with a threaded configuration, forming a terminal end of the elongated pole member, and rotatably coupled to the elongated pole member, the motor operably configured to selectively rotate the anchor member 360° clockwise and 360° counterclockwise independent of a portion of the elongated pole member; and
a canopy covering coupled to the elongated pole member, of a flexible material, and operably configured to have a retracted position with the canopy covering disposed in a longitudinal orientation and an open position with the canopy covering disposed in a horizontal orientation relative to the elongated pole member.

2. The beach umbrella with motorized implanting base according to claim 1, further comprising:
a button disposed on the elongated pole member at least 15% a pole member length above the terminal end of the elongated pole member and configured to selectively activate the motor and rotate the anchor member, the pole member length defined by two opposing ends of the elongated pole member.

3. The beach umbrella with motorized implanting base according to claim 2, further comprising:
a USB charging port electrically coupled to the battery and disposed on the elongated pole member at least 15% the pole member length above the terminal end of the elongated pole member.

4. The beach umbrella with motorized implanting base according to claim 1, wherein:
the elongated pole member and the anchor member are of a unitary structure.

5. The beach umbrella with motorized implanting base according to claim 1, wherein:
the elongated pole member tapers in thickness toward the terminal end to form a point.

6. The beach umbrella with motorized implanting base according to claim 1, wherein:
the elongated pole member encapsulates the motor, the motor comprising an axle disposed in a longitudinal orientation and shaped and sized to mate with a proximal end of the anchor member.

7. The beach umbrella with motorized implanting base according to claim 1, wherein:
the motor operates on 18 VDC, has a power output of approximately 250 W, and is operably configured to rotate approximately 300 RPM.

8. A beach umbrella with motorized implanting base comprising:
a pole member with a first end, a second end opposing the first end of the pole member, a pole member length separating the first and second ends of the pole member, having a motor coupled thereto, disposed proximal to the second end, and electrically coupled to a battery coupled to the pole member, and having an anchor member coupled to the second end of the pole member, with a threaded configuration, having a terminal end, a proximal end opposing the terminal end and operably coupled to the motor, and rotatably coupled to the pole member, the motor operably configured to selectively rotate the anchor member 360° clockwise and 360° counterclockwise independent of the pole member; and
a canopy covering coupled to the pole member, of a flexible material, and operably configured to have a retracted position with the canopy covering disposed in a longitudinal orientation and an open position with the canopy covering disposed in a horizontal orientation relative to the pole member.

9. The beach umbrella with motorized implanting base according to claim 8, further comprising:
a button disposed on the pole member at least 15% the pole member length above the second end of the pole member and configured to selectively activate the motor and rotate the anchor member.

10. The beach umbrella with motorized implanting base according to claim 8, further comprising:
a USB charging port electrically coupled to the battery and disposed on the pole member at least 15% the pole member length above the second end of the pole member.

11. The beach umbrella with motorized implanting base according to claim 8, wherein:
the pole member and the anchor member are of a unitary structure.

12. The beach umbrella with motorized implanting base according to claim 8, wherein:
the anchor member tapers towards the terminal end to form a point.

13. The beach umbrella with motorized implanting base according to claim 8, wherein:
the pole member encapsulates the motor, the motor comprising an axle disposed in a longitudinal orientation and shaped and sized to mate with a proximal end of the anchor member.

14. The beach umbrella with motorized implanting base according to claim 8, wherein:
the motor operates on 18 VDC, has a power output of approximately 250 W, and is operably configured to rotate approximately 300 RPM.

15. The beach umbrella with motorized implanting base according to claim 8, wherein:
the pole member is of an elongated configuration.
